(19) United States
(12) Patent Application Publication
(10) Pub. No.: US 2015/0096501 A1
(43) Pub. Date: Apr. 9, 2015

(54) Animal Tie-Out Device

(71) Applicants: Ross E. Monk, Jacksonville, IL (US); Lori L. Quigg, Jacksonville, IL (US)

(72) Inventors: Ross E. Monk, Jacksonville, IL (US); Lori L. Quigg, Jacksonville, IL (US)

(21) Appl. No.: 14/047,234

(22) Filed: Oct. 7, 2013

(51) Int. Cl. A01K 1/04

(52) U.S. Cl. CPC A01K 1/04
USPC 119/769

(57) ABSTRACT

An animal tie-out device including a hoop consisting of two or more sections that can he assembled and disassembled from each other, and attached to a vertical, object, and a secondary ring attached at one end to the circular hoop, and at the other end to an animal restraint.

### BACKGROUND OF THE INVENTION

The present invention relates to animal tie-out devices.

Dog owners in particular have likely had occasion to tie dogs out for exercise, fresh air, potty privileges, and general handling. Dog-loving families often attempt to safely restrain their pets while providing them with mobility during their time outside, only to find upon their return a pet who is tangled, twisted, and whose movements arc restricted sometimes to the point of little or no mobility due to a fouled tether or tie-out.

Concern over finding an animal tormented by being wrapped tightly against a tree, post, or stake tie-out because of a fouled condition led to the present invention. It was also important that any solution be cost-effective and affordable to pet lovers regardless of means.

Internet searches and discussions with other pet owners, as well as past observations and experience, have revealed various problems with prior animal tie-outs. For example, screw-in stakes with a handle on top have been used in the past, and these have a tendency to foul. Driven-in stakes using a swivel have also been employed, and these tend to pull out from the ground over time, particularly with larger or more powerful animals. Tether cables tied around a tree or pole have also been used, but the cable folds over and/or binds against the tree or pole, wrapping around the tree or pole until the animal is confined or immobilized. Some dogs have even been known to chew on the cable, separating the strands and eventually breaking free.

Accordingly, it would be highly desirable to provide an animal tie-out which is functional, animal-friendly, and relatively inexpensive, and overcomes the disadvantages of prior animal tie-outs, as described above.

Definition Of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Hoop” means a circular, generally circular or elliptical shaped support for an animal restraint, which may be made of any suitable strong and rigid or semi-rigid material useful for tethering an animal, and whose strength and design is chosen with the animal to be tethered in mind.

### SUMMARY OF THE INVENTION

The objects mentioned above, as well as other objects, are solved by the present invention, which overcomes disadvantages of prior animal tie-outs, while providing new advantages not previously obtainable with such tie-outs.

In one preferred embodiment of the present invention, an animal tie-out device includes a hoop including two or more sections that can he assembled and disassembled from each other, the hoop attachable to a vertical object (such as a tree, shrub, pole or post), and a secondary ring attached at one end to the hoop, and at the other end to an animal restraint (such as a chain, rope or cable). In one embodiment, the hoop may be circular or generally circular in cross-section, and may be hollow metal tubing. Fasteners, such as screws, pop rivets, etc., may be used to enable assembly and disassembly of the two or more hoop sections.

In another preferred embodiment, the hoop diameter may be selectively enlarged or shrunk, but still retains a generally circular or elliptical in cross-sectional shape. The hoop may be made of any suitable material, preferably which allows the inner portion contacting the vertical object to have a smooth surface, such as tubular metal, PVC, rubber or a rubber-like material.

In various hoop embodiments, one or more hoop sections may include a female portion, and another of the hoop sections may include a male portion designed to fit within and interconnect with the female portion. Fasteners may be used to secure, or further secure, the male and female sections to each other. In various embodiments, the male portion may be crimped or swagged, or have a tapered or conically-shaped end. Slits may also be formed in an outer portion of the hoop, enhancing flexibility of the hoop.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a perspective view of one embodiment of the animal tie-out device of the present invention, including a hoop, a secondary ring and an animal restraint;

FIG. 2 is a partial perspective view of sections of a preferred hoop embodiment;

FIGS. 3-4 are partial perspective views of another hoop embodiment;

FIG. 5 is a perspective view of yet another hoop embodiment;

FIGS. 6-7 are partial perspective views of hoop sections used in FIG. 5;

FIGS. 8-9 and 10 are partial perspective views of still further hoop embodiments;

FIG. 11 is a cross-sectional view of the hoop section embodiment shown in FIG. 10; and

FIGS. 12-13 are a perspective view, and a. cross-sectional view, respectively, of yet another hoop embodiment.

The components in the drawings are not necessarily to scale, emphasis instead being placed upon clearly illustrating the principles of the present invention.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

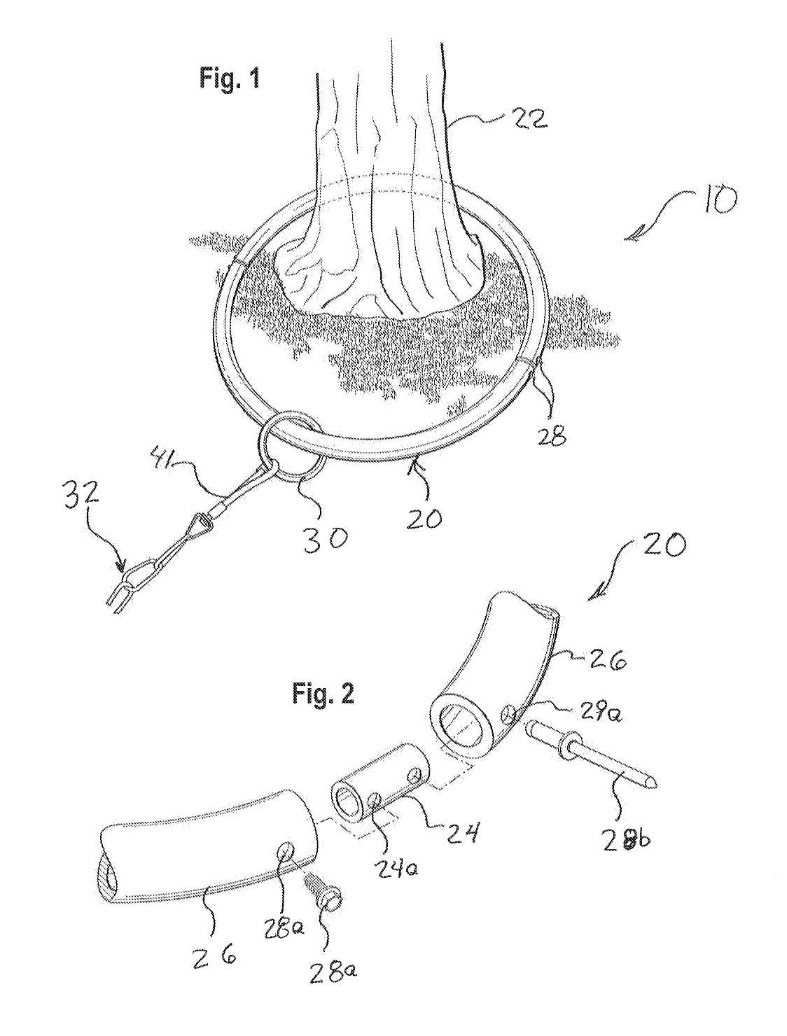

Referring to FIG. 1, in one preferred embodiment of animal tie-out device 10 of the present invention, a rigid or semi-rigid tether hoop 20 is used, which can be placed around a tree, pole, or post 22. A secondary ring 30 may be attached to tether hoop 20 and, in turn, an animal restraint 32 such as a chain, cable or rope may be attached to the secondary ring using any desirable connection 41, such as a releasable detent mechanism, a rope or cable tie, etc. Tether hoop 20 is preferably constructed of durable hollow piping or tubing, while secondary ring 30 preferably consists of a smaller solid ring, which may be made of metal or another strong material. Hoop 20 may be solid metal but, due to its size, which may be 1-foot in diameter or larger, for economic reasons it may be preferable to use a sturdy hollow tubular hoop.

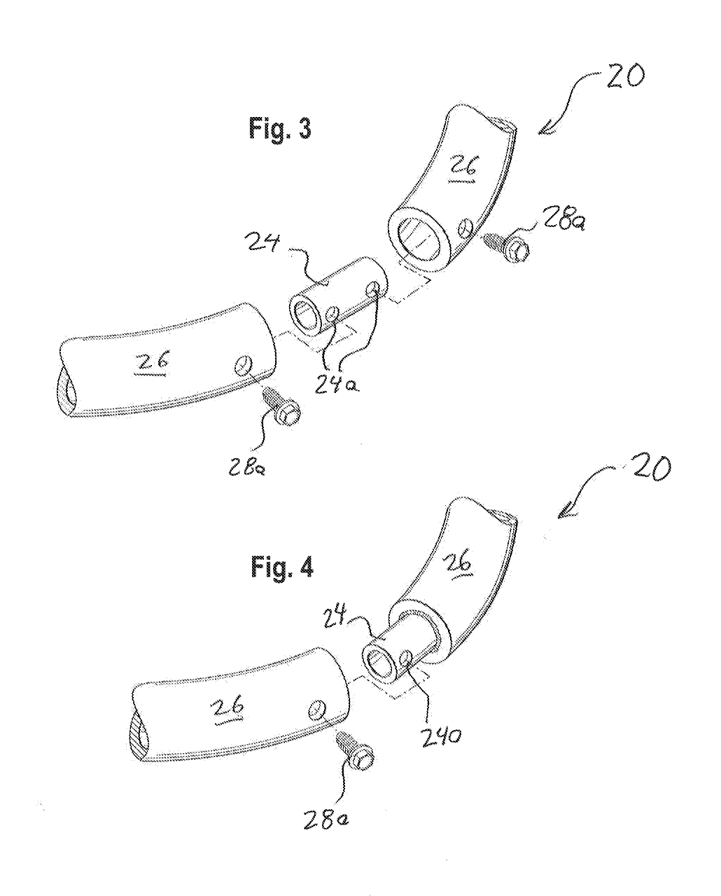

Various embodiments and mechanisms may be used to allow hoop 20 to be disassembled and assembled into sections. Referring to FIGS. 2-3, for example, hoop 20 may include a male section 24 whose opposing ends each fit adjacent female sections 26. Fasteners 28 such as screws or bolts 28a or pop rivets 28b, may be used to secure the sections and form the assembled hoop 20. Male hoop section 24 could also be permanently attached, such as integrally made or with adhesive, to female hoop section 26, as shown in FIG. 4, such that fewer fasteners 28 may be necessary. Preferably, fasteners are used in a manner that keeps the inner surface of hoop 20 smooth, so that it can easily slide about post 22 without binding, and so that ring 30 can freely move about hoop 20 as necessary. This construction also allows hoop 20 to be enlarged, to fit around larger diameter poles, for example.

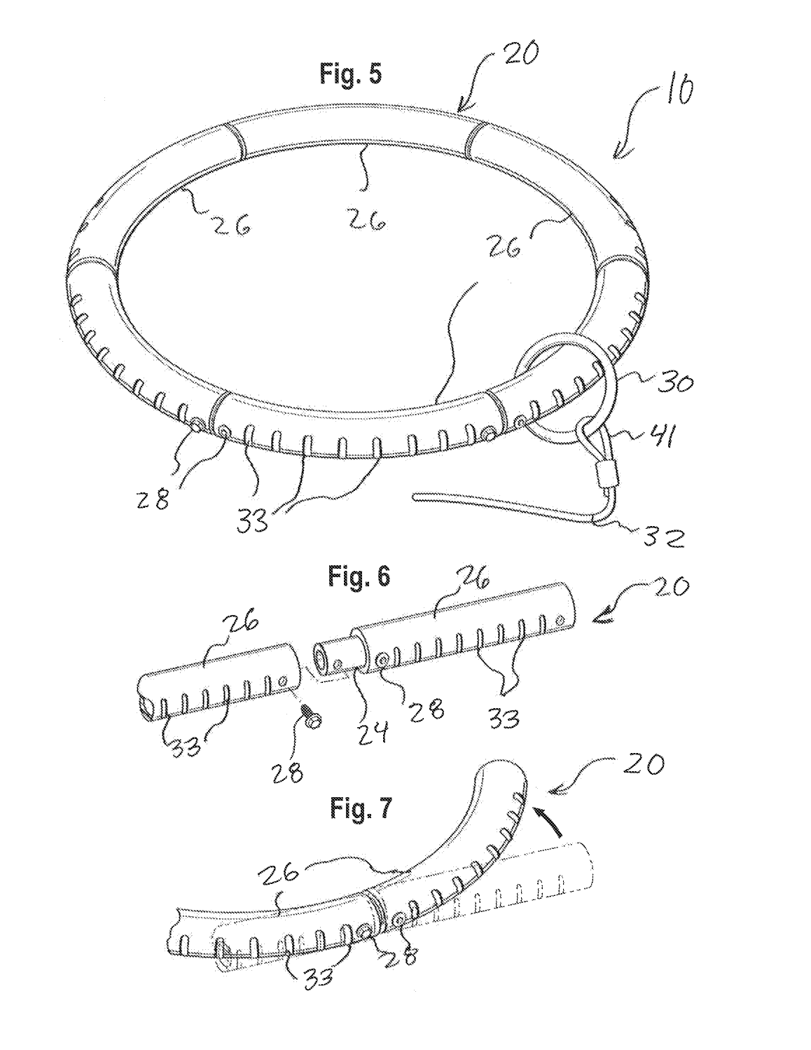

In an alternative embodiment, shown in FIGS. 5-7, slits may be formed on the outer surface of hoop 20, providing hoop 20 with more flexibility, particularly as it is enlarged such that it may be less circular and more elliptical in overall circumferential shape.

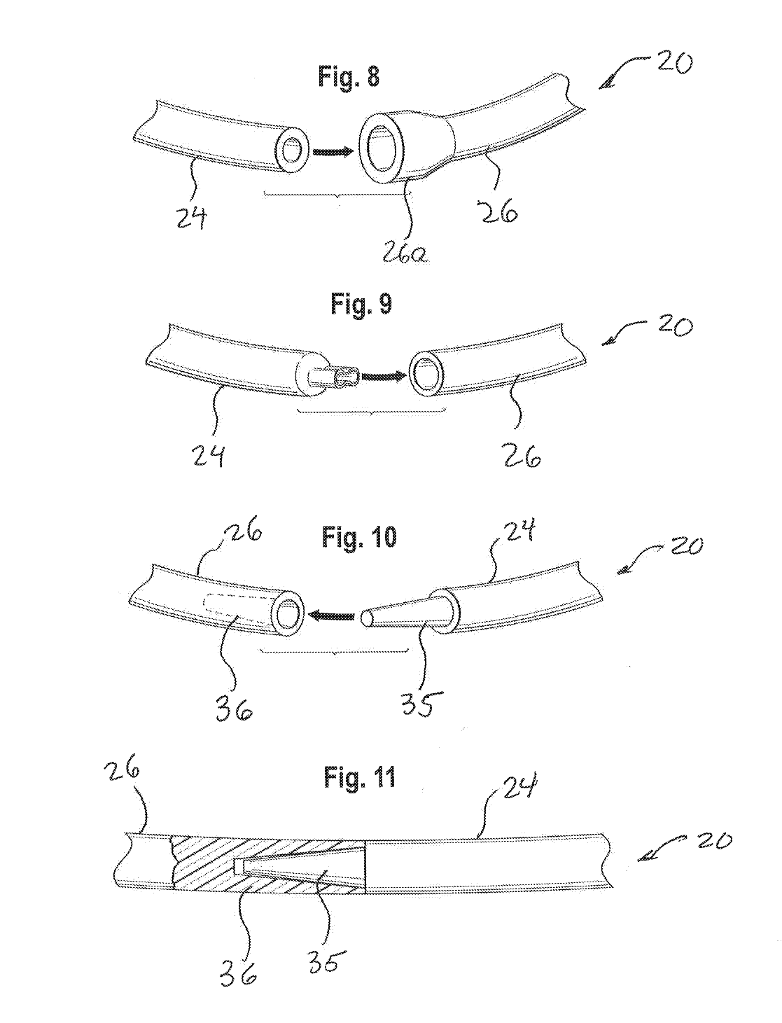

Referring to FIGS. 8-11, other hoop section embodiments may be used. For example, male hoop section 24 could be designed to fit tightly with a female hoop section 26 with an enlarged opening 26a, as in FIG. 8. As another example, male section 24 could have a swagged end 24a tightly fitting within female section 26, as shown in FIG. 9 In still another embodiment, male hoop section 24 could include a conically tapered end 35 tightly fitting within a correspond conically tapered opening 36 within female hoop section 26, as shown in FIGS. 10-11.

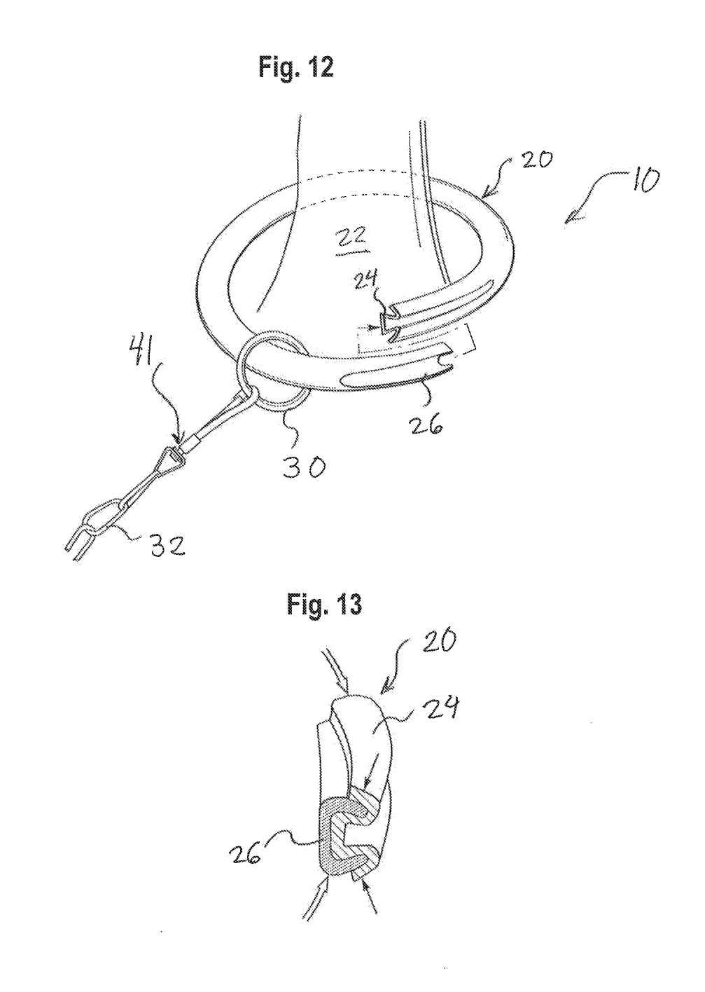

Referring to FIGS. 12-13, in still another embodiment, hoop ends may be crimped such that “male” crimped end 26 may fit within “female” crimped end 24, as shown.

Those of ordinary skill in the art will recognize that various fasteners 28 may be used, such as screws, pop rivets, detents, etc.

Preferably, the hoop and ring are constructed such that they are easy to put in place and easy to remove. A circular or generally circular cross-section for each of the hoop and ring is preferred, as then they will tend not to bind, bend, fray or kink around pole 22 or on each other. Unlike conventional cable tie-outs, preferably no sharp metal strands are involved, which may unravel, loosen, break or stick hands or fingers, or the mouth and paws of pets.

In a particularly preferred embodiment, hoop 20 and secondary ring 30 are made of metal with a smooth, glossy finish, or at least a smooth inner surface, to provide a low coefficient of friction when they rub against each other, providing greater ease of movement of secondary ring 30 as it moves around tether hoop 20, and tether hoop 20 as it moves about pole 22. A secondary benefit of using a metallic hoop with a smooth surface finish is less damage to the bark on trees, and thus less harmful to trees and shrubs.

Referring to FIGS. 5-7, hoop 20 could also be constructed of a rugged rubber, braided or hybrid material, such as but not limited to polyvinyl chloride (PVC)-like materials or garden hose. The above-referenced hoop section embodiments will allow rapid disassembly and assembly of the hoop around poles or trees, and also allow the selective enlarging or shrinking of the hoop diameter, to better fit the diameter of the desired tree or pole used to secure the hoop in place.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

1. An animal tie-out device, comprising:
a primary ring including two or more sections that can be assembled and disassembled from each other, the primary ring attachable to a vertical object; and
a secondary ring attached to the primary ring, and to an animal restraint.

2. The animal tie-out device of claim 1, wherein the primary ring is generally circular in cross-sectional shape and comprises hollow metal tubing.

3. The animal tie-out device of claim 2, wherein the metal tubing includes one or more fasteners enabling two or more sections of the primary ring to be assembled and disassembled from each other.

4. The animal tie-out device of claim 1, wherein the vertical object comprises one or more of the following: a tree; a shrub; a pole; and a post.

5. The animal tie-out device of claim 1, wherein the animal restraint comprises one or more of the following: a chain; a rope; and a cable,

6. The animal tie-out device of claim 1, wherein a cross-sectional shape of the hoop may he selectively enlarged or shrunk.

7. The animal tie-out device of claim 1, wherein the primary ring is generally circular or elliptical in cross-sectional shape.

8. The animal tie-out device of claim 1, wherein the primary ring comprises PVC, rubber or a rubber-like material.

9. The animal tie-out device of claim 1, wherein an inner surface of the primary ring is smooth.

10. The animal tie-out device of claim 1, wherein at least one of the primary ring sections includes a female portion, and at least another of the primary ring sections includes a male portion designed to fit within and interconnect with the female portion.

11. The animal tie-out device of claim 10, further comprising one or more fasteners for securing the male and female sections to each other.

12. The animal tie-out device of claim 10, wherein the male portion is crimped or swagged.

13. The animal tie-out device of claim 10, wherein the male portion has a tapered end.

14. The animal tie-out device of claim 10, wherein the male portion has a conically shaped end.

15. The animal tie-out device of claim 1, wherein slits are formed in an outer portion of the primary ring, enhancing flexibility of the primary ring.

16. The animal tie-out device of claim 1, wherein the primary ring comprises a semi-rigid material with an outer surface of PVC, rubber or a rubber-like material.

17. An animal tie-out device, comprising:
a primary ring with at least one portion having opposing ends that can be disassembled from, and assembled to, each other, the primary ring attachable to a vertical object; and
a secondary ring attached to the primary ring, and to an animal restraint.

18. The animal tie-out device of claim 17, wherein the primary ring comprises a semi-rigid material with an outer surface of PVC, rubber or a rubber-like material.
